(19) United States
(12) Patent Application Publication
(10) Pub. No.: US 2014/0227025 A1
(43) Pub. Date: Aug. 14, 2014

(54) Furniture Modeling System with Extendable Members

(71) Applicant: M. RUSSELL GIVEANS, Minnetrista, MN (US)

(72) Inventor: M. RUSSELL GIVEANS, Minnetrista, MN (US)

(21) Appl. No.: 13/767,015

(22) Filed: Feb. 14, 2013

(51) Int. Cl. F16B 7/10

(52) U.S. Cl. CPC F16B 7/10
USPC 403/291

(57) ABSTRACT

A system of extendable members and connectors can be used to model three-dimensional objects, such as furniture. The members and connectors may be arranged to approximate the shape and dimensions of a piece of furniture. In this way, a user of the system can visualize how well the furniture modeled by the system would fit in a space, such as a room. The disclosed embodiments may facilitate three-dimensional visualization of how furniture or other objects will fit in a room or other space. Further, the system may be disassembled easily for transportation and storage.

### TECHNICAL FIELD

This disclosure relates generally to modeling of three-dimensional objects. More particularly, the disclosure relates to constructing models of furniture.

### BACKGROUND

Furniture has presented a challenge in the context of interior space design for quite some time. Some homeowners and other purchasers of furniture have found it difficult to conveniently and accurately visualize how a piece of furniture will fit into a living space. In particular, relying on stated dimensions typically involves measuring a space and determining whether a piece of furniture will fit into it. Another approach involves cutting out a piece of cardboard or other material to match the stated dimensions. This approach, however, can generally only capture the two-dimensional footprint of the furniture. Neither approach provides an adequate way of visualizing a piece of furniture in three-dimensional space.

### SUMMARY OF THE DISCLOSURE

According to various example embodiments, a system of extendable members and connectors can be used to model three-dimensional objects, such as furniture. The members and connectors may be arranged to approximate the shape and dimensions of a piece of furniture. In this way, a user of the system can visualize how well the furniture modeled by the system would fit in a space, such as a room.

In one embodiment, a system for simulating a three-dimensional object includes rigid extendable members that are configured to remain in a substantially linear configuration in an extended state. A connector receives the rigid extendable members and connects the rigid extendable members.

Another embodiment is directed to a connector for receiving a plurality of rigid extendable members. The connector includes a connector body. Flexible members extend from the connector body and define respective receptacles for receiving the rigid extendable members.

The disclosed embodiments may offer a number of advantages. For example, the systems disclosed herein may facilitate three-dimensional visualization of how furniture or other objects will fit in a room or other space. Further, the system may be disassembled easily for transportation and storage.

### BRIEF DESCRIPTION OF THE DRAWINGS

FIG. 1 is a perspective view illustrating an example three-dimensional furniture modeling system according to an embodiment.

FIG. 2 is a plan view illustrating an example extendable member of the three-dimensional furniture modeling system of FIG. 1 in a first configuration.

FIG. 3 is a plan view illustrating the example extendable member of FIG. 2 in a second configuration.

FIG. 4 is a plan view illustrating an example connector that may form part of the three-dimensional furniture modeling system of FIG. 1 according to an embodiment.

FIG. 5 is a plan view illustrating an example connector that may form part of the three-dimensional furniture modeling system of FIG. 1 according to another embodiment.

FIG. 6 is a plan view illustrating an example connector that may form part of the three-dimensional furniture modeling system of FIG. 1 according to yet another embodiment.

FIG. 7 is a plan view illustrating an example connector that may form part of the three-dimensional furniture modeling system of FIG. 1 according to still another embodiment.

FIG. 8 is a plan view illustrating another example extendable member according to another embodiment.

FIG. 9 is a plan view illustrating another example extendable member according to still another embodiment.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

According to various disclosed embodiments, a system of extendable members and connectors can be used to model three-dimensional objects, such as furniture. The members and connectors may be arranged to approximate the shape and dimensions of a piece of furniture or another three-dimensional object. In this way, a user of the system can visualize how well the furniture modeled by the system would fit in a space, such as a room. The systems disclosed herein may facilitate three-dimensional visualization of how furniture or other objects will fit in a room or other space. Further, the system may be disassembled easily for transportation and storage.

The system may comprise extendable members and connectors. The members can be extendable in a number of ways, including, for example, telescoping or folding or unfolding of corrugations. The members are preferably sufficiently rigid to maintain a relatively straight configuration even when extended to their full length. The connectors may be implemented as elbow-style connectors. In one embodiment, one side of the elbow is fixed, while the other side can be moved or pivoted. In another embodiment, both sides of the elbow can be moved or pivoted. In still another embodiment, the connector may have more than two arms into which the extendable members can be inserted. Some or all of these arms may be movable or pivotable.

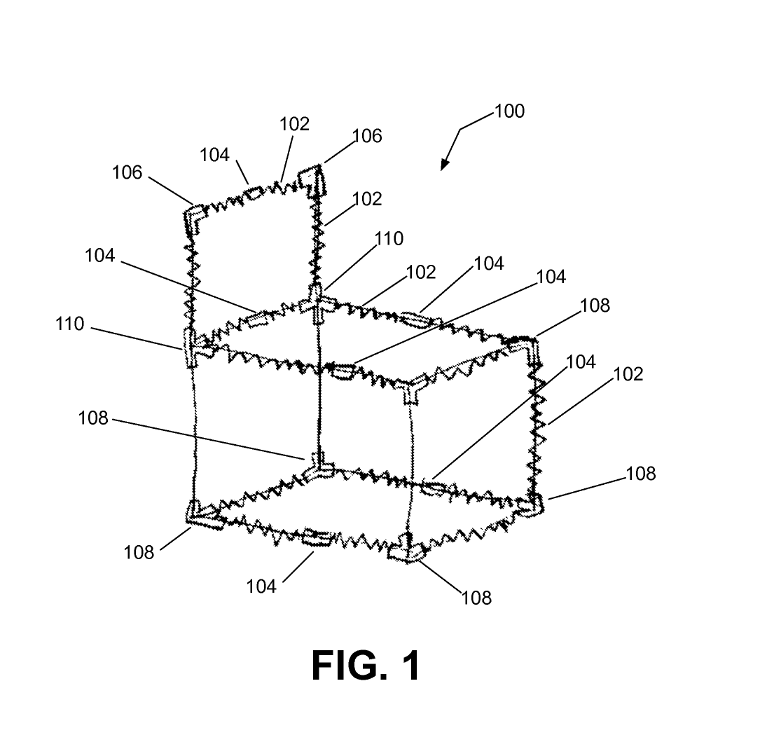

FIG. 1 is a perspective view illustrating an example three-dimensional furniture modeling system 100 according to an embodiment. The furniture modeling system 100 includes extendable members 102 that are connected using connectors. As shown in FIG. 1, the furniture modeling system 100 may include several different types of connectors. For example, the furniture modeling system 100 may include straight connectors 104 that connect two extendable members 102 in a substantially straight line. The furniture modeling system 100 may also include corner connectors 106 that connect two extendable members 102 at an angle, e.g., a 90° angle. Some connectors may connect more than two extendable members 102. For example, other corner connectors 108 may connect three extendable members 102 at an angle or angles, e.g., mutually orthogonally. Still other connectors 110 may connect more than three extendable members 102. The connectors 110 shown in FIG. 1, for instance, connect four extendable members 102, with three of the extendable members 102 connected mutually orthogonally, and with the fourth extendable member 102 connected in a substantially straight line with one of the other extendable members 102.

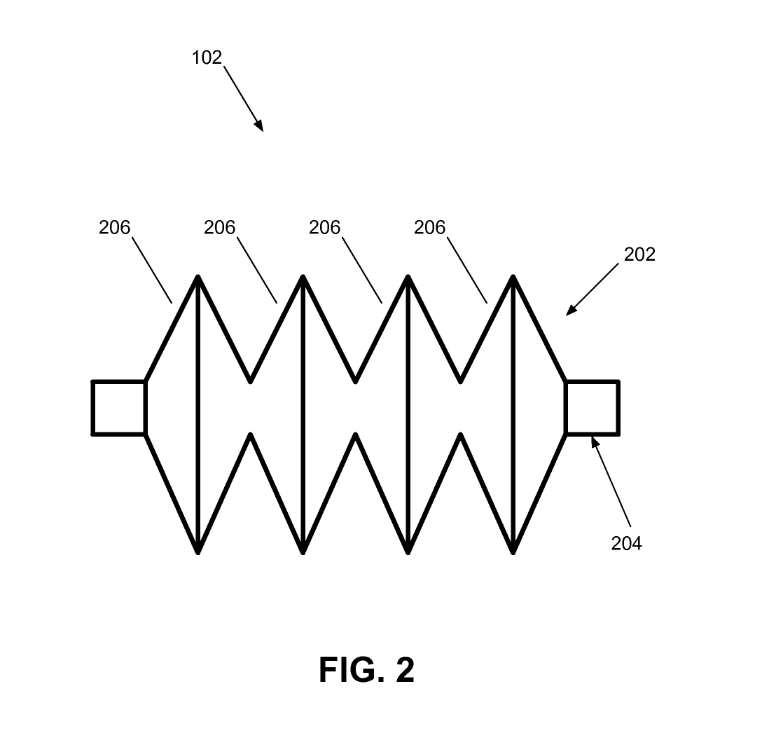

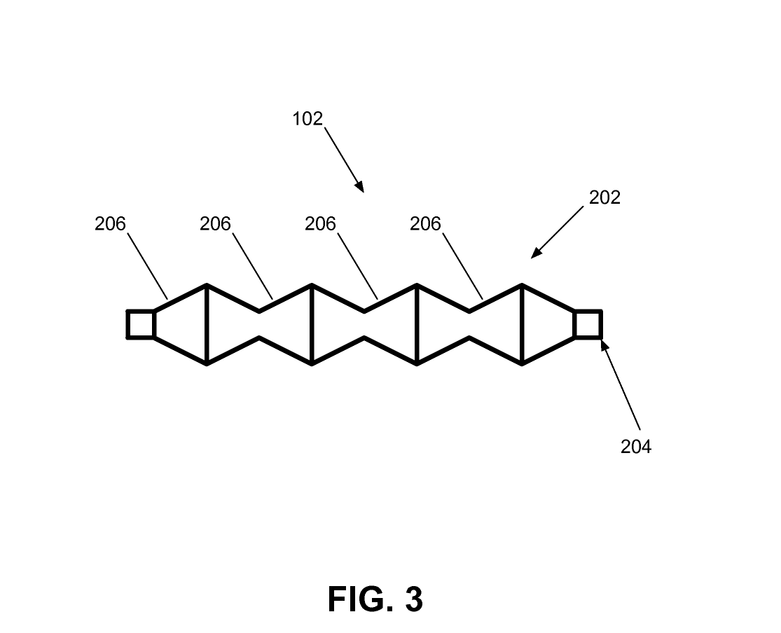

The extendable members 102 can be implemented in a number of ways. In one embodiment, for example, the extendable members 102 are implemented as collapsible members. FIG. 2 is a plan view illustrating an example extendable member 102 in a collapsed configuration. FIG. 3 is a plan view illustrating the example extendable member 102 in an extended configuration. The extendable member 102 may be implemented as a rigid plastic or metal member that has an expandable body 202 and a connection portion 204. The expandable body 202 may have a number of corrugations or baffles 206 that can be collapsed, as shown in FIG. 2, or expanded, as shown in FIG. 3. In this way, the extendable member 102 can assume a range of desired lengths, for example, between 8″ in the configuration shown in FIGS. 2 and 24″ in the configuration shown in FIG. 3. In one embodiment, the baffles 206 may be sufficiently rigid that, in either the collapsed or expanded configuration, the extendable member 102 maintains a substantially linear shape, i.e., does not curve or bend substantially.

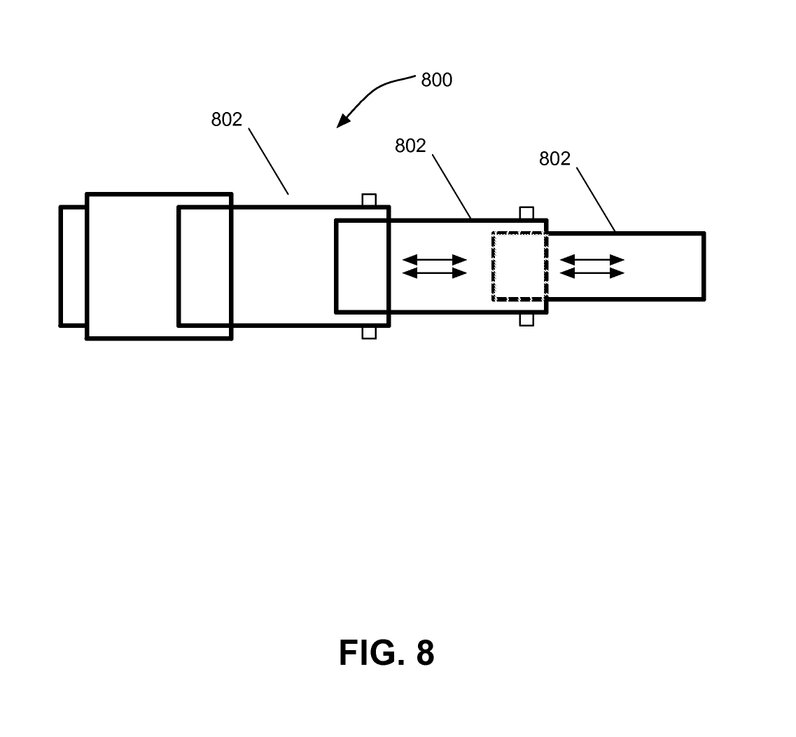

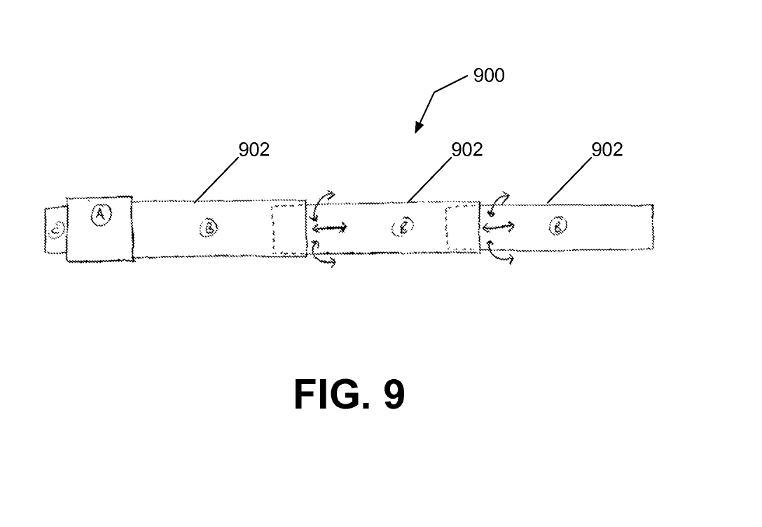

While the extendable members 102 are depicted in FIGS. 2 and 3 as being implemented using expandable baffles 206, persons of ordinary skill in the art will appreciate that the extendable members 102 can be implemented in other embodiments. For example, the extendable members 102 can be implemented as telescoping members, with each member able to be collapsed or expanded from within itself, and locked in the position of a desired length. FIGS. 8 and 9 illustrate example embodiments in which an extendable member 102 is implemented as a telescoping member 800 or a telescoping member 900. The telescoping members 800 and 900 include two or more sections 802 or 902 that can be expanded or collapsed into one another to adjust an effective length of the telescoping member 800 or 900. As another example, the extendable members 102 can be implemented as members having multiple components, and the length of the members can be adjusted and fixed at a certain length by rotating the components of the members relative to one another.

In some embodiments, the extendable members 102 may incorporate indicia indicating the current lengths of the extendable members 102. The current length of an extendable member 102, for example, may be indicated on a side of the extendable member 102.

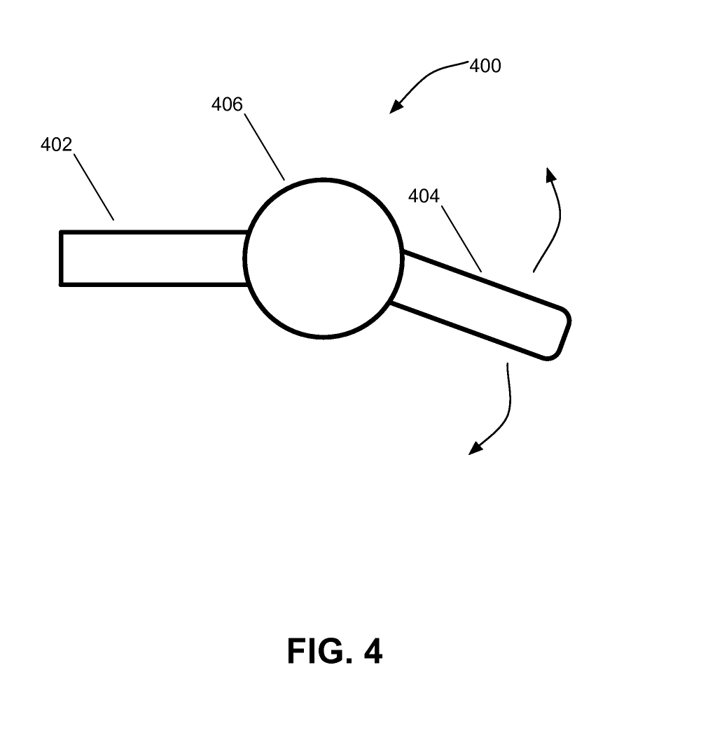

The extendable members 102 may be connected to one another via a variety of connectors. FIG. 4 is a plan view illustrating an example connector 400 that may form part of the three-dimensional furniture modeling system 100 of FIG. 1 according to an embodiment. The connector 400 includes a first portion 402 and a second portion 404 connected to one another via an elbow portion 406. The first portion 402 and the second portion 404 have receptacles formed in them to receive the connection portions 204 of the extendable members 102. In the embodiment shown in FIG. 4, the first portion 402 is fixed in that it cannot be moved relative to the elbow portion 406. The second portion 404, however, is adjustable. In particular, the second portion 404 can be moved relative to the elbow portion 406 so that it forms any of a range of angles with the first portion 404. In some embodiments, both the first portion 402 and the second portion 404 may be adjustable in that both the first portion 402 and the second portion 404 can be moved relative to the elbow portion 406.

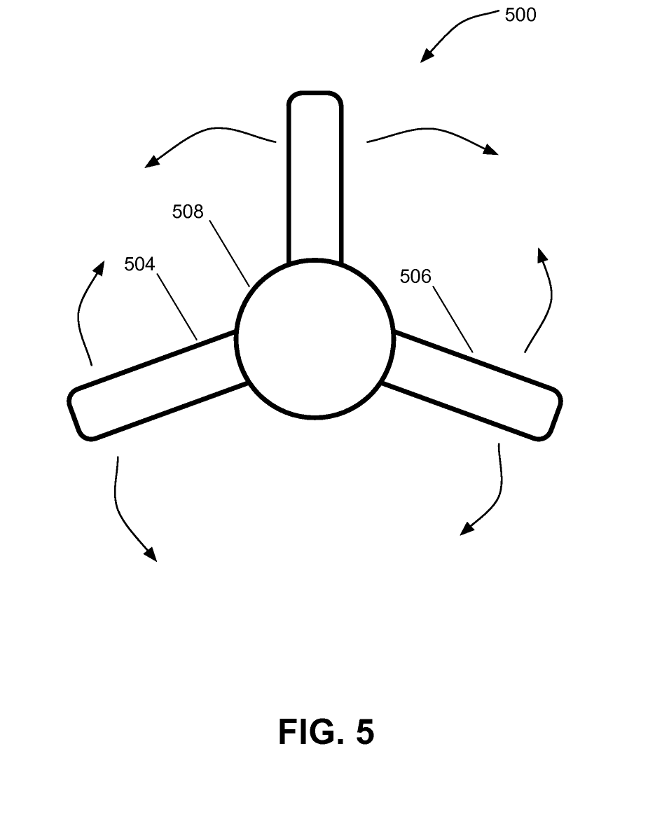

FIG. 5 is a plan view illustrating an example connector 500 that may form part of the three-dimensional furniture modeling system 100 according to another embodiment. The connector 500 includes a first portion 502, a second portion 504, and a third portion 506. The first portion 502, the second portion 504, and the third portion 506 are connected to one another via a connection portion 508 and have receptacles formed in them to receive the connection portions 204 of the extendable members 102. In the embodiment shown in FIG. 5, the first portion 502, the second portion 504, and the third portion 506 are adjustable in that each of these portions can be moved relative to the connection portion 508 so that they form any of a range of angles with each other. It will be appreciated that, in some embodiments, one or more of the first portion 502, the second portion 504, and the third portion 506 may be fixed in that it or they cannot be moved relative to the connection portion 508. Further, it will be appreciated that other embodiments of the connector 500 may include more than three portions that are connected to one another via the connection portion 508.

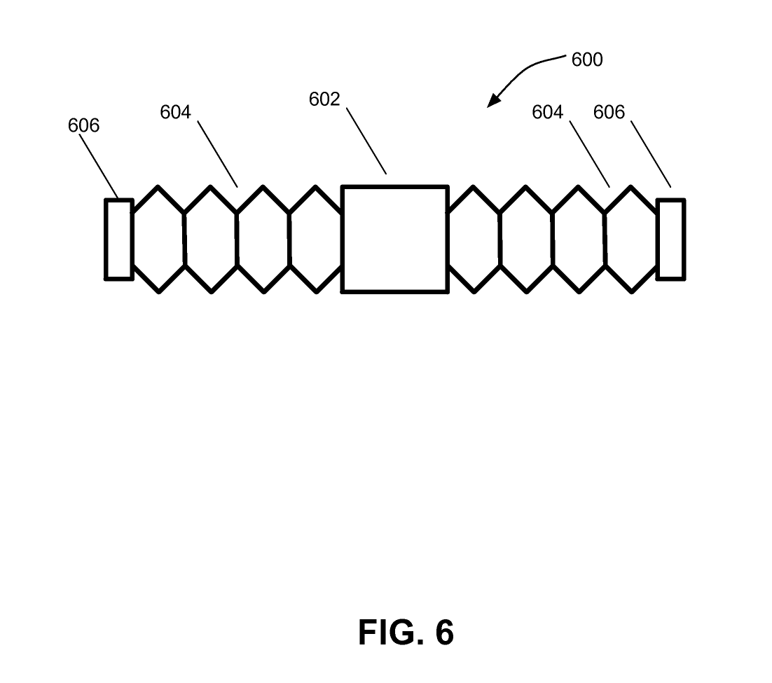

FIG. 6 is a plan view illustrating another example connector 600 that may form part of the three-dimensional furniture modeling system 100. The connector 600 is a unidirectional connector that connects extendable members 102 in a substantially straight-line connection. The connector 600 includes a connector body 602 that is a fixed base. Connector necks 604 are attached to the connector body 602 and may be flexible or bendable to a desired angle and may include corrugations to promote flexibility. Connector receiver portions 606 are located at or near the ends of the connector 600 and form receptacles for receiving extendable members 102.

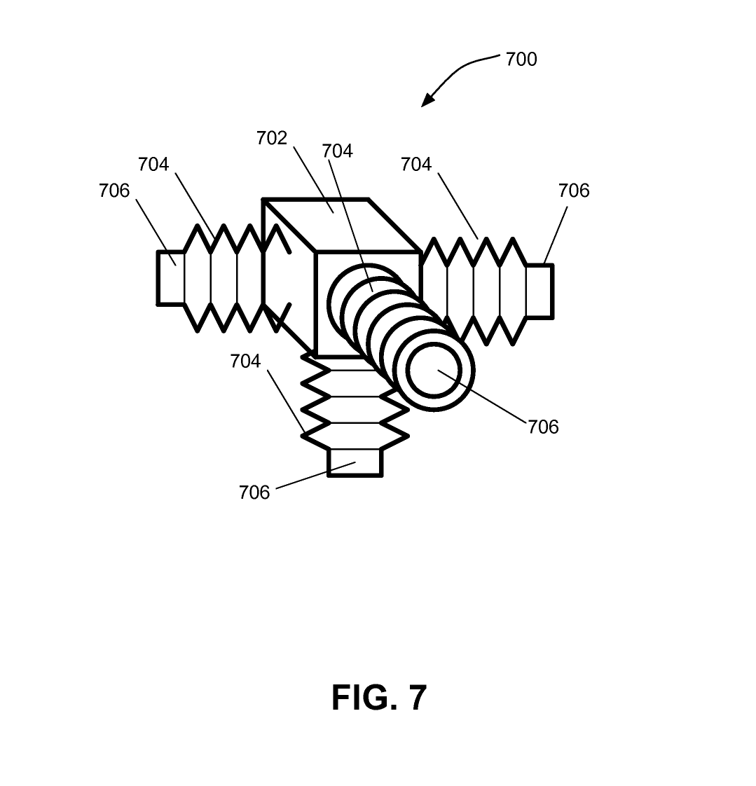

FIG. 7 is a plan view illustrating yet another example connector 700 that is a multi-directional connector. The connector 700 connects multiple, e.g., four extendable members 102 at a corner. It will be appreciated that the connector may connect more or fewer extendable members 102 than illustrated in FIG. 7. A connector body 702 is a fixed base from which one or more connector necks 704 extend. The connector necks 704 may be flexible or bendable to a desired angle and may include corrugations to promote flexibility. While FIG. 7 depicts four connector necks 704, it will be appreciated that more or fewer connector necks 704 may be employed. As a particular example, a cubical connector body 702 may have a connector neck 704 extending from each of its six faces, allowing it to connect up to six extendable members 102.

As demonstrated by the foregoing discussion, various disclosed embodiments may offer a number of advantages. For example, the systems disclosed herein may facilitate three-dimensional visualization of how furniture or other objects will fit in a room or other space. In particular, because the extendable members 102 are adjustable in length and can be connected to one another using any of a variety of connector types, a user can readily simulate a variety of three-dimensional objects and thereby gain an appreciation of how a proposed piece of furniture might fit into a room. Further, the system may be disassembled easily for transportation and storage. Even when assembled, simulated pieces of furniture are substantially lighter than actual pieces of furniture and thus easier to move around a room.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A system for simulating a three-dimensional object, the system comprising:
a plurality of rigid extendable members configured to remain in a substantially linear configuration in an extended state; and
a connector configured to receive the rigid extendable members and to connect the rigid extendable members.

2. The system of claim 1, wherein at least one of the rigid extendable members comprises a telescoping member.

3. The system of claim 1, wherein at least one of the rigid extendable members has a plurality of corrugations formed therein, the corrugations being movable to adjust a length of the at least one of the rigid extendable members.

4. The system of claim 1, wherein at least one of the rigid extendable members is configured to indicate a current length of the at least one of the rigid extendable members.

5. The system of claim 1, wherein the connector comprises a fixed portion and a movable portion.

6. The system of claim 1, wherein the connector comprises a plurality of movable portions.

7. The system of claim 1, wherein the connector comprises a plurality of fixed portions.

8. The system of claim 1, wherein the connector comprises:
a connector body; and
at least one flexible member extending from the connector body, the flexible member defining a receptacle for receiving a rigid extendable member.

9. The system of claim 8, wherein the connector body has a plurality of mutually orthogonal surfaces, the connector further comprising a plurality of flexible members, each flexible member extending from a mutually orthogonal surface of the connector body.

10. A connector for receiving a plurality of rigid extendable members, the connector comprising:
a connector body; and
a plurality of flexible members extending from the connector body and defining respective receptacles for receiving the rigid extendable members.

11. The connector of claim 10, wherein the connector body has a plurality of mutually orthogonal surfaces.

12. The connector of claim 11, wherein each flexible member of the plurality of flexible members extends from a respective mutually orthogonal surface.

13. The connector of claim 10, wherein the connector body comprises a fixed portion and a movable portion.

14. The connector of claim 10, wherein the connector body comprises a plurality of movable portions.

15. The connector of claim 10, wherein the connector body comprises a plurality of fixed portions.
